(19) United States
(12) Patent Application Publication
(10) Pub. No.: US 2025/0187844 A1
(43) Pub. Date: Jun. 12, 2025

(54) PROCESSING DEVICE, HANDLING SYSTEM, PROCESSING METHOD, AND STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Kazuhide SAWA, Kawasaki (JP); Harutoshi CHATANI, Yokohama (JP); Kazunobu KONDA, Suginami (JP); Atsushi SUGAHARA, Kawasaki (JP); Seiji TOKURA, Kawasaki (JP); Junichiro OOGA, Kawasaki (JP); Akihito OGAWA, Fujisawa (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/967,744

(22) Filed: Dec. 4, 2024

(30) Foreign Application Priority Data
Dec. 8, 2023 (JP) 2023-208080

(51) Int. Cl. B65G 43/08

(52) U.S. Cl. CPC B65G 43/08; B65G 2203/0241; B65G 2203/041

(57) ABSTRACT

According to one embodiment, a processing device is configured to communicate with a handling device including a handling robot and an inspection unit; the handling robot transfers an article; and the inspection unit inspects the transferred article. The processing device is configured to detect an occurrence of an error of the handling device. The processing device is configured to determine a process in which the error occurred and a cause of the occurrence of the error. The processing device is configured to determine a change of management information of the article due to the error by using a determination result of the process and a determination result of the cause.

### CROSS-REFERENCE TO RELATED APPLICATIONS

This application is based upon and claims the benefit of priority from Japanese Patent Application No. 2023-208080, filed on Dec. 8, 2023; the entire contents of which are incorporated herein by reference.

### FIELD

Embodiments described herein relate generally to a processing device, a handling system, a processing method, and a storage medium.

### BACKGROUND

Handling robots that are configured to automatically transfer articles are used in warehouses and the like. There is a need for technology for transfer processing using a handling robot in which the ratio of utilization of the handling robot can be further increased.

### BRIEF DESCRIPTION OF THE DRAWINGS

FIG. 1 is a perspective view showing a handling device according to an embodiment;

FIG. 2 is a schematic view showing a configuration example of a handling system according to the embodiment;

FIG. 3 is a schematic view showing a specific configuration example of the handling system according to the embodiment;

FIG. 4 is a table showing an example of an article database;

FIG. 5 is a schematic view showing the overall processing flow of the handling system according to the embodiment;

FIG. 6 is a flowchart showing recovery processing when an error occurs;

FIG. 7 is a schematic view showing a graphical user interface during remote operation;

FIG. 8 is a schematic view showing a graphical user interface during remote operation; and

FIG. 9 is a schematic view showing a hardware configuration.

### DETAILED DESCRIPTION

According to an embodiment, a processing device is configured to communicate with a handling device including a handling robot and an inspection unit; the handling robot transfers an article; and the inspection unit inspects the transferred article. The processing device is configured to detect an occurrence of an error of the handling device. The processing device is configured to determine a process in which the error occurred and a cause of the occurrence of the error. The processing device is configured to determine a change of management information of the article due to the error by using a determination result of the process and a determination result of the cause.

Exemplary embodiments will now be described with reference to the drawings. The drawings are schematic or conceptual; and the relationships between the thickness and width of portions, the proportional coefficients of sizes among portions, etc., are not necessarily the same as the actual values thereof. Furthermore, the dimensions and proportional coefficients may be illustrated differently among drawings, even for identical portions.

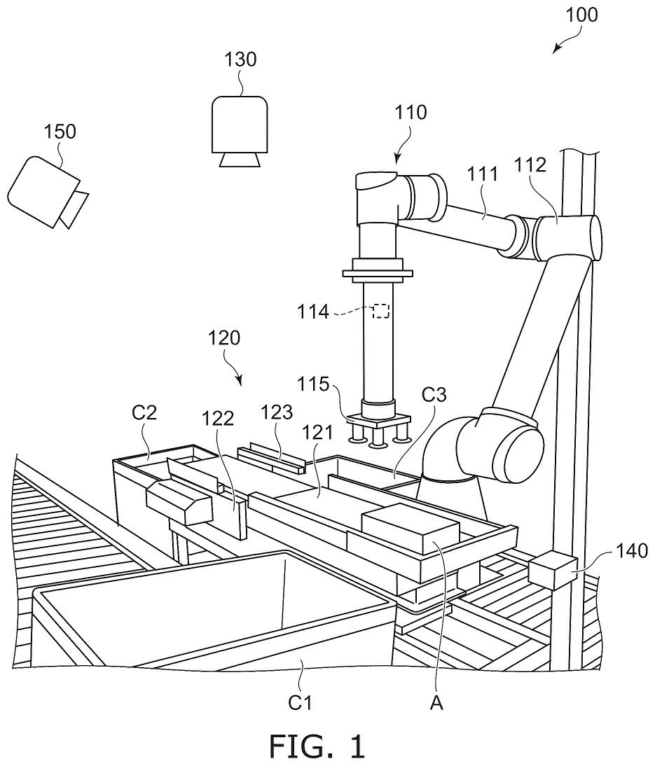

FIG. 1 is a perspective view showing a handling device according to an embodiment.

As shown in FIG. 1, the handling device 100 according to the embodiment includes a handling robot 110, an inspection unit 120, a first measurement device 130, a second measurement device 140, and an imaging device 150.

The handling robot 110 includes a gripper 115 that grips an article; and the handling robot 110 uses the gripper 115 to transfer the article. The gripper 115 grips the article by suction, pinching, etc. For example, the handling robot 110 is a picking robot that performs a picking task.

In the illustrated example, the handling robot 110 is a vertical articulated robot that grips the article by suction. The handling robot 110 includes multiple links 111 and multiple rotation axes 112. The links 111 are connected to each other by the rotation axes 112. The gripper 115 is mounted to the distal end of the handling robot 110. The position and angle of the distal end of the handling robot 110 are changed by operating the rotation axes 112.

Other than a vertical articulated robot, the handling robot 110 may be a horizontal articulated robot, an orthogonal robot, a parallel link robot, etc. It is favorable for the distal end of the handling robot 110 to have at least six degrees of freedom to be able to transfer various articles.

The handling robot 110 includes a sensor 114 that detects forces applied to the gripper 115. For example, the sensor 114 includes at least one selected from a force sensor and an acceleration sensor. Contact between the gripper 115 and the object to be gripped, contact between the gripper 115 and an unintended object, etc., can be detected based on the detection result of the force from the force sensor. The transfer speed due to the gripper 115, the article being dropped while being transferred, etc., can be detected based on the detection result of the acceleration from the acceleration sensor.

A container into which articles are placed by a person or another transfer device is located proximate to the handling robot 110. The handling robot 110 transfers the instructed articles from the container to another location.

The inspection unit 120 inspects whether or not the articles and the number of the articles transferred by the handling robot 110 are correct. In the illustrated example, the inspection unit 120 includes a conveyor 121, a weight sensor 122, and a guide 123.

An article A that is transferred by the handling robot 110 is placed on the conveyor 121. The conveyor 121 transfers the article A in a horizontal direction. The weight sensor 122 is located at a portion of the transfer path of the conveyor 121 and measures the weight of the article transferred by the conveyor 121. The weight sensor 122 also inspects the article A based on the measured weight.

A shipping container C2 and a discharge container C3 are located adjacent to the conveyor 121. The guide 123 is located partway through the transfer path of the conveyor 121 and guides the article transferred by the conveyor 121 toward the shipping container C2 or the discharge container C3. One end of the guide 123 is fixed so that the guide 123 is rotatable along the horizontal plane. By the rotation of the guide 123, the guide 123 is switched between a state in which the guide 123 guides the article toward the shipping container C2 and a state in which the guide 123 guides the article toward the discharge container C3.

For example, the weight sensor 122 determines whether or not the transferred article matches the instructed article. In the case where the weight sensor 122 determines that the transferred article and the instructed article match, the guide 123 guides the article transferred by the conveyor 121 toward the shipping container C2. In the case where the transferred article and the instructed article are determined not to match, the guide 123 guides the article transferred by the conveyor 121 toward the discharge container C3.

The weight sensor 122 also may determine whether or not the article is damaged. Even in the case where the transferred article matches the instructed article, the article is guided toward the discharge container C3 by the guide 123 when the transferred article is determined to be damaged.

The article that is transferred into the discharge container C3 is then inspected by a worker for a problem, and subsequently received (re-received) in the original storage location inside the warehouse.

The first measurement device 130 measures the positions and orientations of the articles contained in a container C1 from above. For example, the first measurement device 130 includes an image sensor and a distance sensor.

The second measurement device 140 measures the size of the article transferred by the handling robot 110 from the side. For example, the second measurement device 140 includes at least one selected from a light sensor and a distance sensor. The article that passes by the side of the second measurement device 140 is detected based on the detection result of the light sensor or the distance sensor. The second measurement device 140 measures the size (the height) of the article in the vertical direction based on the upward transfer speed and the time that the article is detected.

The imaging device 150 images the handling robot 110. The imaging device 150 transmits the captured image to an external terminal device. A user of the terminal device can remotely confirm the state of the handling robot 110 by the image that is imaged by the imaging device 150 being displayed in the terminal device.

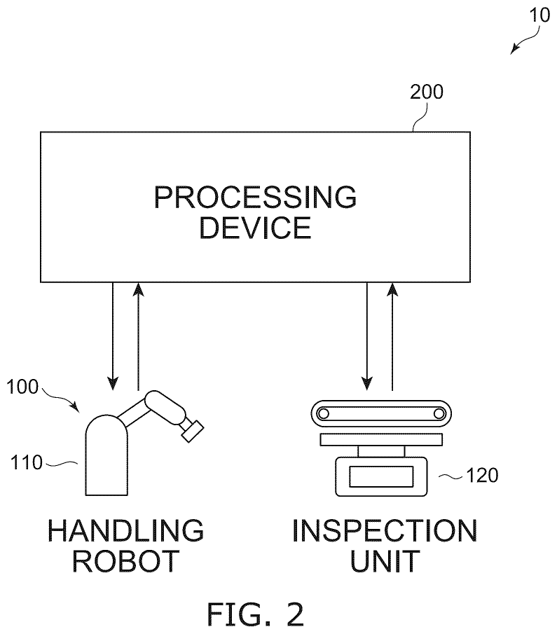

FIG. 2 is a schematic view showing a configuration example of a handling system according to the embodiment.

As shown in FIG. 2, the handling system 10 according to the embodiment includes the handling device 100 and a processing device 200.

The processing device 200 is configured to communicate with the components of the handling device 100. For example, when receiving a transfer instruction, the processing device 200 generates a motion plan. The motion plan includes the transferred article, the grip position, transit positions, the release position, the grip force of the article, the gripping method of the article, the transfer speed of the article, etc.

The processing device 200 transmits the generated motion plan to the handling robot 110. When receiving the motion plan, the robot controller of the handling robot 110 causes motion of the handling robot 110 according to the motion plan.

“Grip position” is the position of the gripper 115 when the article is gripped. “Transit positions” are positions through which the gripper 115 moves during the motion of the handling robot 110. “Release position” is the position at which the article gripped by the gripper 115 is released. “Grip force” is the force necessary to grip the transferred article. When the gripper 115 is capable of multiple methods for gripping the article, “gripping method” indicates one of the methods with which the article is gripped. “Transfer speed” is the speed of the gripper 115 when the handling robot 110 transfers the article.

The measurement result of the first measurement device 130 and the measurement result of the second measurement device 140 are utilized to generate the motion plan. For example, the measurement result of the first measurement device 130 is used to estimate the orientation of the gripper 115 to stably grip the article. The measurement result of the first measurement device 130 and the measurement result of the second measurement device 140 are used to estimate the orientation of the gripper 115 to safely place the article. “Orientation” is represented by the positions in three mutually-orthogonal directions and the angles around the three directions.

The processing device 200 communicates with the handling robot 110 during the motion of the handling robot 110. As the gripper 115 of the handling robot 110 passes through the grip position, transit positions, or the release position, the handling robot 110 transmits the information of the gripper 115 to the processing device 200. When an error of the handling robot 110 occurs, the handling robot 110 transmits the content of the error to the processing device 200. The error that is transmitted from the handling robot 110 may be a software discrepancy of the handling robot 110, contact of the handling robot 110 and an unintended object, the article being dropped while being transferred, etc.

“Unintended object” refers to an object for which contact with the handling robot 110 is not planned in the motion plan. The article to be transferred is not included in the unintended objects because contact with the article to be transferred by the handling robot 110 and gripping by the handling robot 110 of the article to be transferred are planned in the motion plan. For example, unintended objects may include a sidewall of a container, articles other than the transfer object, other robots, etc. Herein, contact of the handling robot 110 with an unintended object is called “interference”.

The inspection unit 120 (the weight sensor 122) transmits the inspection result to the processing device 200. The inspection result is determined based on the relationship between the measurement result of the weight of the transferred article and the weight of the instructed article. For example, based on the relationship between the measured weight and the weight of the instructed article, it is determined whether or not the transferred article matches the instructed article, the transferred quantity matches the instructed quantity, the transferred article is damaged, etc.

For example, in the case where the transfer content such as the transferred articles, the number of transferred articles, etc., match the instruction content such as the instructed articles, the number of instructed articles, etc., and the articles are not damaged, the inspection unit 120 transmits an inspection result of “pass” to the processing device 200. In the case where the transferred article is different from the instructed article, the inspection unit 120 transmits the inspection result of “wrong article” to the processing device 200. In the case where the transferred quantity is different from the instructed quantity, the inspection unit 120 transmits the inspection result of “wrong quantity” to the processing device 200. In the case where the transferred article is damaged, the inspection unit 120 transmits the inspection result of “article damage” to the processing device 200.

An example of an inspection method of the inspection unit 120 will now be described.

Before the transfer of the article is started, the processing device 200 receives information of the article from a higher-level device. The information includes the size, weight, etc., of the article to be transferred. When the articles are transferred one at a time by the handling robot 110, the weight sensor 122 compares the measured weight to the weight according to the data obtained beforehand for each article. In the case where the difference between the measured weight and the weight according to the data is less than a first threshold, the weight sensor 122 determines that the transferred article matches the instructed article. The setting method of the first threshold is arbitrary. For example, the first threshold is set to some value between 5 to 50% of the weight according to the data.

In the case where the measured weight is greater than the weight according to the data and the difference is not less than the first threshold but less than a second threshold, the weight sensor 122 determines that multiple articles are being transferred. The second threshold is greater than the first threshold. For example, the second threshold is set to some value between 2.2 to 3.0 times the weight according to the data. In the case where it is determined that multiple articles are being transferred, the transferred articles are guided toward the discharge container C3 and collected. Such a case is processed as “wrong quantity”.

In the case where the measured weight is greater than the weight according to the data and the difference is not less than the second threshold, the weight sensor 122 determines that a different article from the instructed article is being transferred. In such a case, the transferred article is guided toward the discharge container C3 and collected. Such a case is processed as “wrong article”.

The weight sensor 122 determines that the transferred article is damaged in the case where the measured weight is less than the weight according to the data, the difference is not less than the first threshold, and the measured weight is not less than a minimum measurement value. In such a case, the transferred article is guided toward the discharge container C3 and collected. The “minimum measurement value” is the minimum measurable weight value, and is set by considering the error of the weight meter. Such a case is processed as “article damage”.

In the case where the measured weight is less than the minimum measurement value, the weight sensor 122 determines that the number of transferred articles is zero. In such a case, there is a possibility that the transferred article has caught on the handling robot 110 or has been dropped partway through the transfer. Such a case is processed as “wrong quantity”.

The inspection unit 120 also may include an image sensor. The image sensor includes an imaging device that images the article from above. For example, the image sensor uses the image obtained by the imaging device to determine whether or not the transferred article matches the instructed article and determine whether or not the transferred article is damaged. Technology such as template matching, etc., can be used for such determinations.

The processing device 200 detects the occurrence of an error based on information received from the handling robot 110 or the inspection unit 120. When the occurrence of the error is detected, the processing device 200 determines the process in which the error occurred and the cause of the occurrence of the error. Then, based on the process determination result and the cause determination result, the processing device 200 determines a change of the management information of the article due to the error. The management information is, for example, the inventory quantity. In other words, the processing device 200 determines whether or not an article that cannot be dispatched from the warehouse has occurred due to the error. In the case where an article that cannot be dispatched has occurred, the processing device 200 determines the number of articles that cannot be dispatched. Or, the management information is other information related to the inventory of the article.

The processing device 200 outputs the determination result related to the change of the inventory quantity of the article due to the error. For example, the information of the inventory quantity of the article is corrected based on the determination result of the processing device 200. Thereafter, the transfer instruction is generated based on the corrected inventory quantity.

The handling system according to the embodiment is applicable to a site such as a warehouse, etc., in which articles are stored. The processing device 200 receives the transfer instruction from the higher-level system managing the inventory of the articles in the warehouse, and generates the motion plan according to the instruction.

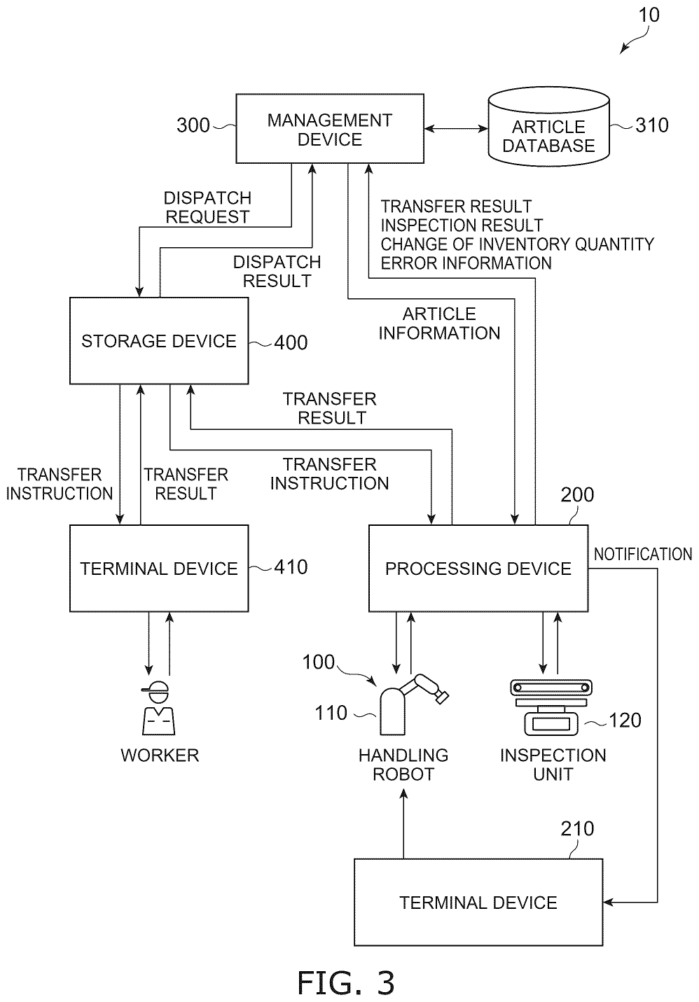

FIG. 3 is a schematic view showing a specific configuration example of the handling system according to the embodiment.

As shown in FIG. 3, the handling system 10 according to the embodiment also may include a management device 300 and a storage device 400.

The management device 300 is a higher-level system that manages the entire handling system 10. For example, the management device 300 functions as a warehouse management system (WMS). The management device 300 manages article inventory such as inventory management, history management, etc., in real time. When the management device 300 receives a transfer instruction from an even higher-level system, a dispatch request is transmitted to the storage device 400. The dispatch request designates the articles and number of the articles, and requests a container in which the articles are placed to be fetched and transferred to the location of the handling robot 110 or the worker. The management device 300 accesses an article database 310 and transmits the information of the instructed articles to the processing device 200.

The storage device 400 manages the articles stored in the warehouse. The storage device 400 transmits the transfer instruction to the processing device 200 or a terminal device 410 according to the dispatch request. The transfer instruction instructs the designated number of articles to be extracted from the dispatched container. The processing device 200 generates a motion plan according to the transfer instruction and causes motion of the handling robot 110. The instructed number of the instructed articles is transferred by the motion of the handling robot 110. The inspection unit 120 inspects the transferred articles based on the information of the articles transmitted from the management device 300. The articles that pass the inspection are contained in the shipping container.

When the transfer instruction is received, the terminal device 410 displays the transfer instruction on a monitor. The worker follows the displayed transfer instruction and picks the instructed number of the instructed articles. The worker inspects the picked articles and places the articles without problems in the shipping container.

The processing device 200 and the terminal device 410 transmit the transfer result to the storage device 400. The transfer result indicates whether or not the transfer motion of the handling robot 110 is completed, and includes a determination result of one of “transfer success” or “transfer failure”. The processing device 200 also transmits the transfer result and the inspection result to the management device 300. Based on the transfer result received from the processing device 200 and the terminal device 410, the storage device 400 transmits the result of the dispatch request to the management device 300.

In the case where an error has occurred, the processing device 200 transmits the determination result of the change of the inventory quantity and error information to the management device 300. When a transfer result indicating “transfer success” is received, the management device 300 reduces the inventory quantity of the article database 310 regardless of the inspection result. Based on the determination result of the change of the inventory quantity, the management device 300 also emits a notification to the worker to correct the inventory quantity. The worker that receives the notification confirms the condition of the inventory of the article that is the object of the error and corrects the inventory quantity registered in the article database 310.

For example, in the case where “transfer success” is determined, the inventory quantity of the article database 310 is reduced by the management device 300. In the case where “wrong article”, “wrong quantity”, or “article damage” is determined in the inspection and the article transferred by the worker is re-received, the worker increases the inventory quantity of the article database 310. Based on the error information, the management device 300 re-transmits the dispatch request to the storage device 400 for the article of the failed transfer.

The handling system 10 also may include another management device that functions as a warehouse execution system (WES). The management device 300 communicates with the other management device and receives the transfer instruction from the other management device.

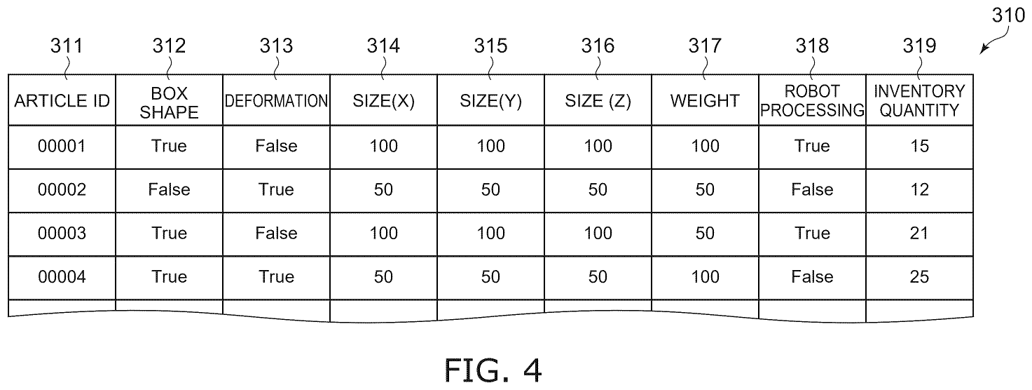

FIG. 4 is a table showing an example of an article database.

As shown in FIG. 4, the article database 310 includes columns of identification information 311 of the article, a box shape 312, deformation 313, a size (X) 314, a size (Y) 315, a size (Z) 316, a weight 317, robot processing 318, and an inventory quantity 319.

The data of the identification information 311 indicates identification information (ID) for each article. The data of the box shape 312 indicates whether or not each article has a box shape. “True” indicates that the article is box-shaped. “False” indicates that the article is not box-shaped. The data of the deformation 313 indicates whether or not each article may deform. “True” indicates that the article may deform when being transferred. “False” indicates that the article will not deform when being transferred.

The data of the size (X) 314, the data of the size (Y) 315, and the data of the size (Z) 316 respectively indicate the width, depth, and height of the article. For example, the units are millimeters. The data of the weight 317 indicates the weight of each article. For example, the units are grams.

The data of the robot processing 318 indicates compatibility with processing by the handling device 100. “True” indicates that the handling robot 110 can transfer the article. “False” indicates that the handling robot 110 cannot transfer the article. An instruction is transmitted from the storage device 400 to the processing device 200 when an article of which the data of the robot processing 318 is “true” is transferred. An instruction is transmitted from the storage device 400 to the terminal device 410 when an article of which the data of the robot processing 318 is “false” is transferred. The data of the inventory quantity 319 indicates the inventory quantity of each article.

Based on the data of the article database 310, the management device 300 transmits the article information to the processing device 200 and transmits a dispatch request to the storage device 400. Also, when a determination result of a change of an inventory quantity is received from the processing device 200, the management device 300 emits a notification requesting confirmation of the inventory status according to the determination result. The worker that receives the notification appropriately corrects the inventory quantity registered in the article database 310. For example, in the case where the determination result indicates that there is no change of the inventory quantity due to an error, the management device 300 does not emit a notification to the worker. In the case where the determination result indicates a reduction of the inventory quantity due to the error, the management device 300 emits a notification to the worker.

As shown in FIG. 3, the handling system 10 also may include a terminal device 210 for remotely operating the handling robot 110. The terminal device 210 is connected with the handling robot 110 via a network.

In the case where an error of the handling robot 110 occurs and it is difficult for the handling robot 110 or the processing device 200 to perform automatic recovery, an operator uses the terminal device 210 to operate the handling robot 110. As a result, the handling robot 110 can recover from the error without the operator going to the site of the handling robot 110. When an error occurs, the period that the handling robot 110 is stopped can be shorter; and the ratio of utilization of the handling device 100 can be increased.

When an error occurs, the processing device 200 may determine the necessity of a remote operation and transmit a notification to the terminal device 210. Because the necessity of the remote operation is determined and a notification is transmitted, it is unnecessary for the operator to monitor the handling robot 110. For example, the operator can supervise multiple handling robots 110.

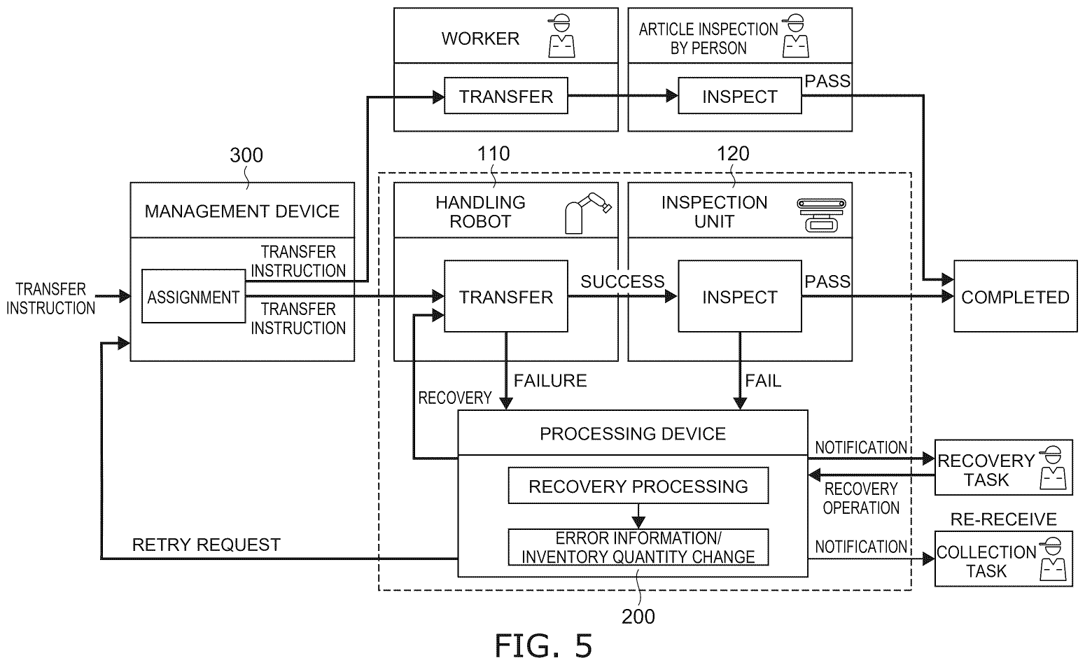

FIG. 5 is a schematic view showing the overall processing flow of the handling system according to the embodiment.

First, the management device 300 receives a transfer instruction from a higher-level management device. The management device 300 assigns the instructed transfer task to a worker or the handling robot 110. The storage device 400 (not illustrated) transfers the container in which the articles are stored to the assignment destination. When the transfer task is assigned to the worker, the worker transfers the articles according to the instruction content and inspects the articles and the number of articles. In the case where the articles and the number of articles are correct, the instructed transfer task is completed.

When the transfer task is assigned to the handling robot 110, the processing device 200 receives the transfer instruction from the management device 300 and performs the transfer to the handling robot 110. In the case where the transfer motion of the handling robot 110 is completed, the processing device 200 processes this case as “transfer success” regardless of whether or not the article has actually been transferred correctly. In the case where the transfer motion of the handling robot 110 is incomplete, the processing device 200 processes this case as “transfer failure”.

After the transfer motion of the handling robot 110 is completed, the inspection unit 120 performs an inspection. In the case where the inspection result is “pass”, the instructed transfer is completed. As described above, an error such as the article being dropped, etc., can be detected based on the information transmitted from the handling robot 110. However, errors that are difficult to detect with the handling robot 110 also may occur in the transfer task, such as mismatch between the transferred article and the instructed article, quantity mismatch, article damage, etc. The inspection unit 120 can detect such errors that are difficult to detect with the handling robot 110. By including the inspection unit 120, the accuracy of the transfer processing performed by the handling device 100 can be increased.

In the case where the transfer by the handling robot 110 fails or the inspection by the inspection unit 120 is “fail”, the processing device 200 detects such errors. The processing device 200 attempts recovery processing when such an error is detected.

For example, in the case where it is determined that a software discrepancy of the handling robot 110 has occurred, the processing device 200 resets the software of the handling robot 110. In the case where it is determined that the article was dropped while being transferred, the processing device 200 re-transfers the article to the handling robot 110. In the case where it is determined in the inspection that the transfer content does not match the instruction content, the processing device 200 re-transfers the article to the handling robot 110. The handling by the handling device 100 is automatically restarted by the recovery processing; and the ratio of utilization of the handling device 100 can be increased.

In the case where automatic recovery processing is difficult and it is determined that remote operation is necessary, the processing device 200 notifies the necessity of a remote operation for recovery to the terminal device 210. When the terminal device 210 receives the notification, the operator performs the recovery processing with a remote operation.

In addition to the recovery processing, the processing device 200 determines the process in which the error occurred and the cause of the occurrence of the error. Based on the determination results, the processing device 200 determines a change of the inventory quantity of the article due to the error. For example, for various cases in which “wrong article”, “wrong quantity”, or “article damage” is determined in the inspection, the processing device 200 outputs a determination result to reduce the inventory quantity of the article by the quantity being transferred. In the case where an error occurs when transferring and the handling robot 110 is gripping the article, the processing device 200 outputs a determination result to reduce the inventory quantity of the article by the quantity being transferred. In the case where the error indicates that the article was dropped while being transferred, the processing device 200 outputs a determination result to reduce the inventory quantity of the article by the quantity being transferred.

When an error occurs, the processing device 200 generates error information indicating the error content based on the process determination result and the cause determination result. In the case where it is necessary to re-transfer the article due to the error, the processing device 200 transmits, to the management device 300, a request to retry the transfer.

When the article is transferred to the discharge container C3, the processing device 200 transmits a notification to the prescribed terminal device. Articles that collect in the discharge container C3 due to the occurrence of errors, articles that were dropped while being transferred, etc., are collected by the worker at any timing. Normal articles without damage, deformation, alteration, etc., are re-received at the storage location of the warehouse. In such a case, the inventory quantity that is registered in the article database is increased by the quantity that is re-received.

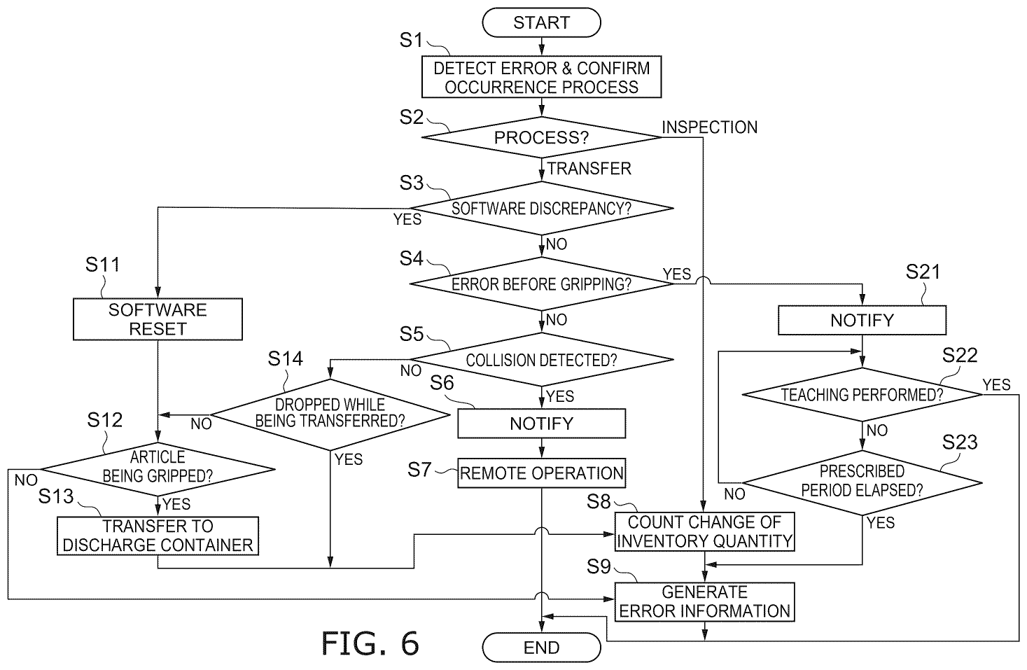

FIG. 6 is a flowchart showing recovery processing when an error occurs.

By performing the recovery processing shown in FIG. 6, the handling device 100 recovers from the error state; and the transfer is restarted. First, when the error occurs in the transfer or the inspection, the processing device 200 detects the error and confirms the process in which the error occurred (step S1). Continuing, the processing device 200 determines the process in which the error occurred (step S2). In other words, it is determined whether or not the error occurred in one of the transfer or the inspection.

In the case where the error occurred when transferring, the processing device 200 determines whether or not the cause of the error is a software discrepancy (step S3). In the case where the determination result is “no” in step S3, the processing device 200 determines whether or not the cause of the error is related to something before gripping the article (step S4). Errors that occur before gripping the article include recognition or plan failures. More specific examples include a case where the recognition of the article by the first measurement device 130 is not correctly completed, a case where the generation of the motion plan by the processing device 200 is not correctly completed, etc.

In the case where the determination result is “no” in step S4, the processing device 200 determines whether or not the cause of the error is the detection of a collision by the handling robot 110 (step S5). When interference of the handling robot 110 occurs, the collision is detected by the sensor 114 of the handling robot 110. The handling robot 110 transmits, to the processing device 200, information indicating that the collision was detected. In the case where the processing device 200 receives such information, the cause of the error is determined to be the detection of the collision.

In the case where the determination result is “yes” in step S5, the processing device 200 notifies the terminal device 210 that a remote operation is necessary (step S6). The operator of the terminal device 210 uses the terminal device 210 to remotely operate the handling robot 110 (step S7). For example, the operator moves the handling robot 110 to a position that does not interfere with objects. Subsequently, the processing device 200 re-generates a motion plan based on the position after the movement. As a result, the transfer by the handling robot 110 is restarted, and the recovery processing ends.

When it is determined that an error occurred in the inspection in step S2, the processing device 200 counts the change of the inventory quantity (step S8). Subsequently, the processing device 200 generates error information (step S9). The processing of the error occurrence ends when step S9 is completed.

In the case where the determination result is “yes” in step S3, the processing device 200 performs a software reset (step S11). As a result, the software discrepancy of the handling robot 110 is resolved. Subsequently, the processing device 200 determines whether or not the handling robot 110 is gripping the article (step S12). In the case where the handling robot 110 is gripping the article, the processing device 200 causes a motion of the handling robot 110 so that the gripped article is transferred to the discharge container C3 (step S13). Subsequently, step S8 is performed. In such a case, the quantity transferred to the discharge container C3 is counted as a reduction of the inventory quantity.

In the case where the determination result is “yes” in step S4, the processing device 200 notifies the terminal device 210 that a remote operation is necessary (step S21). For example, the operator uses the terminal device 210 to teach the handling robot 110 the position for gripping the object. After step S21, the handling robot 110 determines whether or not the teaching has been performed remotely (step S22). In the case where the teaching has not been performed remotely, the handling robot 110 determines whether or not a prescribed period has elapsed from when step S21 was performed (step S23). Step S22 is re-performed in the case where the prescribed period has not elapsed.

Step S9 is performed in the case where the determination result is “yes” in step S23. In the case where the determination result is “yes” in step S22, the handling robot 110 performs a motion to grip the object at the taught position. Therefore, the recovery processing from the error ends. In any case, the inventory quantity of the article is not changed because the error occurred before gripping the article.

In the case where the determination result is “no” in step S5, the processing device 200 determines whether or not the cause of the error is the article being dropped while being transferred (step S14). Step S8 is performed in the case where the determination result is “yes” in step S14. In such a case, the number of articles that were dropped is counted as a reduction of the inventory quantity.

Step S12 is performed in the case where the determination result is “no” in step S14. Errors that are determined to be “no” in step S14 include measurement errors of the second measurement device 140. In the case where the second measurement device 140 cannot measure the height of the article correctly, the processing device 200 tries to generate a motion plan by assuming that the article being gripped has the maximum size that can be handled. Then, in the case where a motion plan that can transfer the article of the maximum size cannot be generated, an error is emitted to indicate that it is impossible for the processing device 200 to transfer.

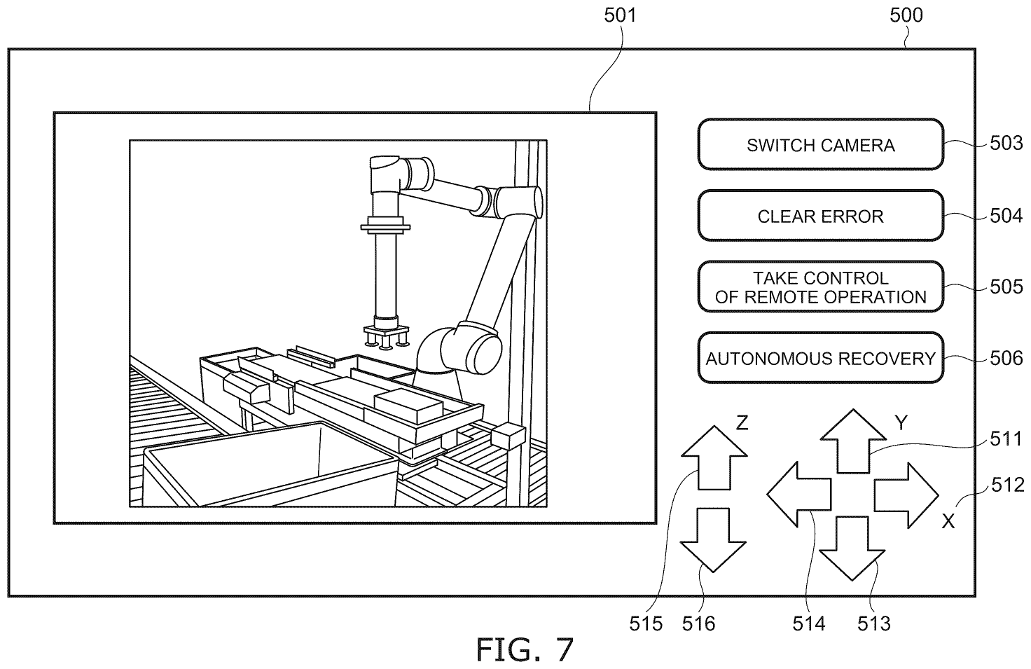

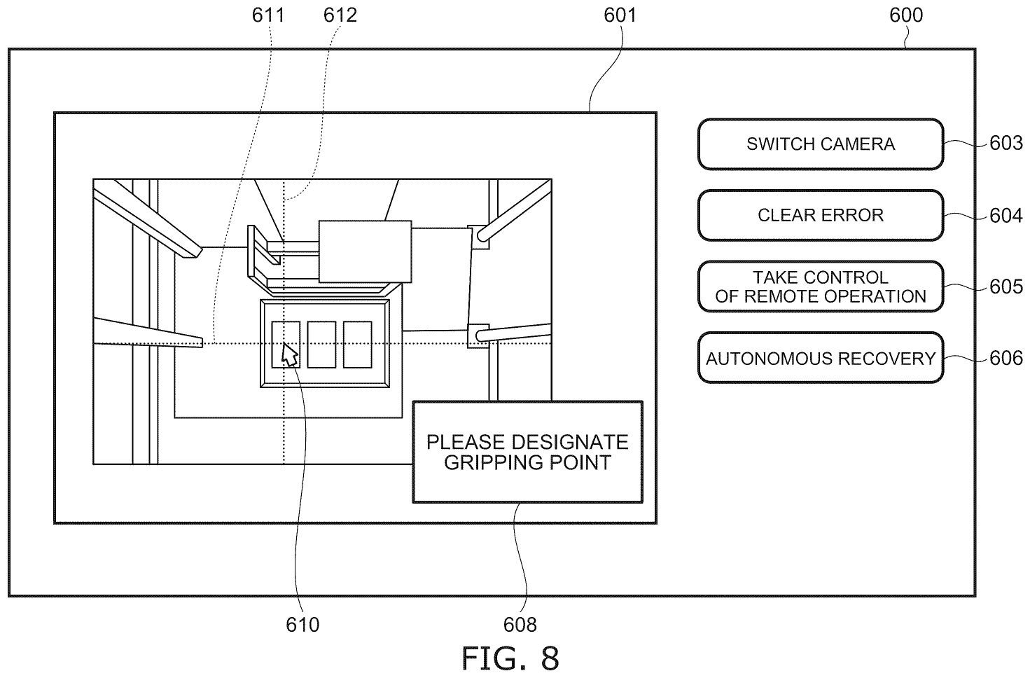

FIGS. 7 and 8 are schematic views showing graphical user interfaces during remote operation.

When performing the remote operation, the terminal device 210 displays, on a monitor, a graphical user interface (GUI) for performing remote operation of the handling robot 110.

In the case where the remote operation of step S7 is performed, the terminal device 210 displays, for example, a GUI 500 shown in FIG. 7. The GUI 500 includes a display region 501, icons 503 to 506, and icons 511 to 516.

An image that is imaged by an imaging device is displayed in the display region 501. For example, when the imaging device obtains an image, the image is displayed in the display region 501 in real time. The icon 503 is an icon for switching the image displayed in the display region 501. In the illustrated example, the image that is imaged by the imaging device 150 is displayed. When multiple imaging devices are located around the handling robot 110, the icon 503 can be used to select the imaging device of which the image is to be displayed in the display region 501.

The icon 504 is an icon for clearing the error of the handling robot 110. By clearing the error, the handling robot 110 is set to an operable state. The icon 505 is an icon for taking control of the remote operation. By clicking the icon 505, the operator can take control of the remote operation of the handling robot 110. The icon 506 is an icon for causing the handling robot 110 and the processing device 200 to autonomously perform a recovery operation.

The icons 511 to 516 are icons for remotely operating the handling robot 110. The icons 511 to 514 are icons for causing motion of the handling robot 110 in two horizontal directions (an X-direction and a Y-direction). The icons 515 and 516 are icons for causing motion of the handling robot 110 in the vertical direction (the Z-direction).

When the operator clicks one of the icons 511 to 516, the gripper 115 moves in one of the X-direction, the Y-direction, or the Z-direction according to the operation of the icon. The operator clicks the icon 506 after moving the gripper 115 to a position at which interference does not occur. According to this operation, the processing device 200 re-generates a motion plan based on the position to which the gripper 115 is moved by the operator. Subsequently, the handling robot 110 performs motions according to the generated motion plan.

In the case where a remote operation is performed after step S21, the terminal device 210 displays, for example, a GUI 600 shown in FIG. 8. The GUI 600 includes a display region 601 and icons 603 to 606.

A real time image that is imaged by an imaging device is displayed in the display region 601. The icon 603 is an icon for switching the image displayed in the display region 601. In the illustrated example, the image that is imaged by the imaging device of the first measurement device 130 is displayed. Imaging devices for obtaining images to be displayed in the GUI 600 may be located around the handling robot 110.

The icon 604 is an icon for clearing the error of the handling robot 110. The icon 605 is an icon for taking control of the remote operation. The icon 606 is an icon for causing the handling robot 110 and the processing device 200 to autonomously perform a recovery operation.

A message 608 is an instruction to the operator. After taking control of the remote operation by clicking the icon 605, the operator uses a pointing device (a mouse or the like) of the terminal device 210 to move a cursor 610. The operator follows the instruction of the message 608 and designates the gripping point of the gripper 115 by moving the cursor 610 to the gripping point. After moving the cursor 610 to the gripping point, the operator clicks the icon 606. The processing device 200 generates a motion plan so that the article is gripped at the designated point. Subsequently, motions of the handling robot 110 are performed according to the generated motion plan.

Auxiliary lines 611 and 612 may be displayed while the cursor 610 is present on the display region 601. The auxiliary lines 611 and 612 are straight lines extending respectively in the lateral direction and the vertical direction. Because the auxiliary lines 611 and 612 are displayed, the operator can easily confirm the point selected by the cursor 610.

Advantages of the embodiment of the invention will now be described.

Various errors may occur when an article is transferred using the handling robot 110. As described above, errors include software discrepancies, interference, the article being dropped, recognition or plan failures, mismatch between the transfer content and the instruction content, etc. Conventionally, when such an error occurs, the worker confirms the occurrence of a change of the inventory quantity and appropriately corrects the inventory quantity of the article database 310.

According to a conventional method, the worker must confirm the occurrence of the change of the inventory quantity each time an error occurs. In other words, the transferring by the handling robot 110 is stopped until the change of the inventory quantity is confirmed and the information of the article database 310 is corrected. A method may be considered in which the transferring by the handling robot 110 is restarted without confirming the change of the inventory quantity, regardless of the occurrence of the error. However, in such a case, there is no information regarding whether or not the error occurred when transferring the article, which container the article was transferred from, when the error occurred, what needs to be confirmed to confirm the inventory quantity, etc. Therefore, much time is necessary for the confirmation by the worker.

For such problems, according to the embodiment of the invention, the processing device 200 detects the occurrence of the error of the handling device 100. The processing device 200 determines the process in which the error occurred and the cause of the occurrence of the error. Then, the processing device 200 uses the process determination result and the cause determination result to determine the change of the inventory quantity of the article due to the error. As a result, the worker can collectively confirm the change of the inventory quantity after the occurrence of multiple errors according to the determination result of the change of the inventory quantity for each error.

For example, it is unnecessary for the worker to confirm the inventory quantity for an error for which the processing device 200 determines that the inventory quantity did not change. For an error for which it is determined that the inventory quantity did not change, the worker can ascertain the time of the occurrence of the error based on the time at which the error was detected. Also, the worker can ascertain where to search for the article based on the process of the error and the cause of the error.

According to the embodiment of the invention, the time that the handling robot 110 is stopped to confirm the inventory can be reduced; and the ratio of utilization of the handling robot can be improved.

To determine the process, the processing device 200 determines whether or not the error occurred in one of the transferring by the handling robot 110 or the inspecting by the inspection unit 120. In the case where the error occurred in the inspection, the processing device 200 outputs a determination result to reduce the inventory quantity of the article.

In the case where it is determined that the error occurred in the transferring by the handling robot 110 and the cause of the error is the article being dropped, the processing device 200 outputs a determination result to reduce the inventory quantity of the article.

In such a case, the management device 300 may correct the compatibility information of the dropped article to indicate the compatibility with the processing according to the handling robot 110. For example, when the article was dropped, the management device 300 modifies the data of the robot processing 318 of the article in the article database 310 from “true” to “false”. As a result, if an article has been dropped, the subsequent transfer task of that article is performed by a worker. As a result, the occurrence of errors of the handling robot 110 can be suppressed, and the ratio of utilization of the handling robot 110 can be further increased.

In the case where an error occurred in the transfer by the handling robot 110, the processing device 200 appropriately determines whether or not an article is being gripped by the handling robot. For example, the processing device 200 determines whether or not the article is being gripped in the case where the cause of the error is a software discrepancy, or in the case where the cause of the error is the article being dropped and is unrelated to something before gripping. In the case where it is determined that the article is being gripped by the handling robot 110, the processing device 200 outputs a determination result to reduce the inventory quantity of the article.

A determination result not to change the inventory quantity of the article is output in the case where an error occurred in the transfer by the handling robot 110 and the cause of the error is related to something before the handling robot 110 gripped the article.

As in the example above, by using the process determination result and the cause determination result to determine the change of the inventory quantity, the worker can subsequently collectively confirm changes of the inventory quantity due to multiple errors more quickly and accurately.

In the case where an error occurred in the transfer by the handling robot 110, the processing device 200 may determine the necessity of a remote operation of the handling robot 110. In the case where the remote operation is determined to be necessary, the processing device 200 emits a notification. For example, the notification is transmitted to the terminal device 210; and the operator of the terminal device 210 remotely operates the handling robot 110 according to the notification. The operator can cause the handling robot 110 to recover from the error without going to the site at which the handling robot 110 is installed. Therefore, the period that the handling robot 110 is stopped can be shorter, and the ratio of utilization of the handling device 100 can be further increased.

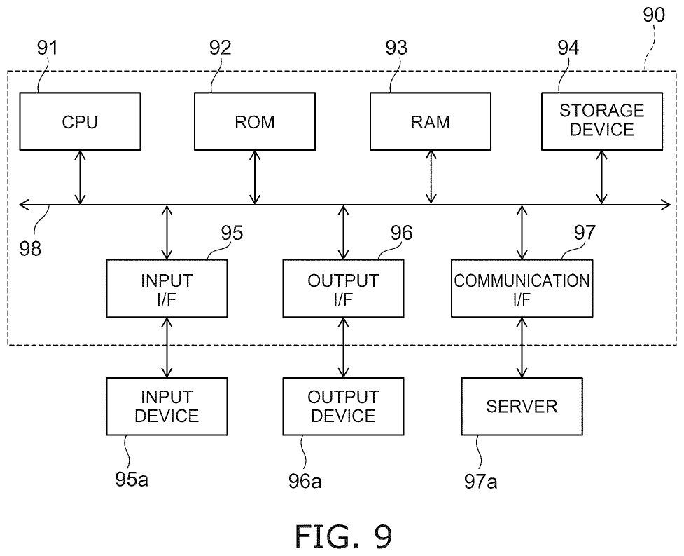

FIG. 9 is a schematic view showing a hardware configuration.

For example, a computer 90 shown in FIG. 9 includes the processing device 200, the management device 300, the storage device 400, etc. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The CPU 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HPMI (registered trademark)), etc. The CPU 91 can transmit data to the output device 96a via the output I/F 96 and cause the output device 96a to output the data.

The communication interface (I/F) 97 can connect the computer 90 and a server 97a outside the computer 90. The communication I/F 97 is, for example, a network card such as a LAN card, etc. The CPU 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing performed by the processing device 200, the management device 300, or the storage device 400 may be realized by one computer 90, or may be realized by collaboration of multiple computers 90. One computer 90 may function as two or more selected from the processing device 200, the management device 300, and the storage device 400.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

According to the embodiments above, a processing device, a handling system, a processing method, a program, and a storage medium that can further increase the ratio of utilization of a handling robot are provided.

In the specification, “or” indicates that “at least one” of the matters enumerated in the text can be employed.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments herein may be made without departing from the spirit of the inventions. The accompanying claims and their equivalents are intended to cover such forms or modifications as would fall within the scope and spirit of the inventions. The embodiments above can be implemented in combination with each other.

What is claimed is:

1. A processing device configured to communicate with a handling device, the handling device including a handling robot and an inspection unit, the handling robot transferring an article, the inspection unit inspecting the transferred article, the processing device being configured to:
detect an occurrence of an error of the handling device;
determine a process in which the error occurred and a cause of the occurrence of the error; and
determine a change of management information of the article due to the error by using a determination result of the process and a determination result of the cause.

2. The processing device according to claim 1, wherein
the determination of the process includes determining whether or not the error occurred in one of the transferring by the handling robot or the inspecting by the inspection unit.

3. The processing device according to claim 2, wherein
the management information includes an inventory quantity of the article.

4. The processing device according to claim 3, further configured to:
output a determination result to reduce the inventory quantity of the article in the case where the error occurs in the inspecting by the inspection unit.

5. The processing device according to claim 3, further configured to:
output a determination result to reduce the inventory quantity of the article in the case where it is determined that the error occurred in the transferring by the handling robot, and it is determined that the cause of the error is the article being dropped.

6. The processing device according to claim 3, further configured to:
determine whether or not the article is being gripped by the handling robot in the case where the error occurred in the transferring by the handling robot; and
output a determination result to reduce the inventory quantity of the article in the case where it is determined that the article is being gripped by the handling robot.

7. The processing device according to claim 3, further configured to:
output a determination result not to change the inventory quantity of the article in the case where the error occurred in the transferring by the handling robot, and the cause of the error is related to something before the handling robot gripped the article.

8. The processing device according to claim 1, further configured to:
determine a necessity of a remote operation of the handling robot in the case where the error occurred in the transferring by the handling robot; and
emit a notification in the case where the remote operation is determined to be necessary.

9. A handling system, comprising:
the processing device according to claim 1; and
the handling device.

10. The handling system according to claim 9, further comprising:
a management device configured to communicate with the processing device,
the processing device transmitting, to the management device:
a transfer result indicating a success or a failure of the transferring of the article; and
a determination result of the change of the management information of the article.

11. The handling system according to claim 10, wherein
the management device accesses an article database including compatibility information for each article, the compatibility information indicating compatibility with the transferring by the handling robot, and
the management device corrects the compatibility information for the article that was dropped in the case where the article was dropped by the handling robot.

12. The handling system according to claim 11, further comprising:
a terminal device configured to communicate with the handling robot via a network and configured to remotely operate the handling robot.

13. A processing method, comprising:
communicating with a handling device, the handling device including a handling robot and an inspection unit, the handling robot transferring an article, the inspection unit inspecting the transferred article;
detecting an occurrence of an error of the handling device;
determining a process in which the error occurred and a cause of the occurrence of the error; and
determining a change of management information of the article due to the error by using a determination result of the process and a determination result of the cause.

14. A storage medium configured to store a program,
the program causing a computer to perform the processing method according to claim 13.
